(19) United States
(12) Patent Application Publication
(10) Pub. No.: US 2013/0223677 A1
(43) Pub. Date: Aug. 29, 2013

(54) System for counting trapped insects

(71) Applicant: Kirk Ots, Ajax (CA)

(72) Inventor: Kirk Ots, Ajax (CA)

(21) Appl. No.: 13/403,421

(22) Filed: Feb. 23, 2012

(51) Int. Cl. G06K 9/00; A01M 1/10

(52) U.S. Cl. 382/103; 43/107

(57) ABSTRACT

This is a method of counting trapped insects that makes it possible to count the trapped insects without having to open the trap. The method involves using a trap made with a transparent polymer making up at least one side of the trap allowing an image to be made of the insects trapped inside with an imaging device.

### BACKGROUND OF THE INVENTION

The present invention is a new way to monitor the control of insects by using a trap that allows the insects trapped inside to be counted and a recorded image provided of the trapped insects without the need to open the trap.

In a pest control effort the most effective and often the only way to control insect presence is through proper hygiene practices. To evaluate whether a hygiene program is effecting traps are placed throughout the area of interest. After a set period of time has passed the number of trapped insects is counted and recorded to evaluate whether the hygiene program is effective. This counting usually involves opening the trap and sometimes even filtering the trapped insects out of the attractant.

### SUMMARY OF THE INVENTION

To overcome the above mentioned drawbacks in conventional trapped insect monitoring it is the object of the present invention to provide a way of counting the trapped insects and provide a recorded image for record and future comparison.

(1) Accordingly at least one side of the trap is comprised of a transparent polymer.

(2) When it is desired to count the insects trapped in the trap an image is made through a transparent side of the trap using a devise whose purpose is to record an image. Possible devices that can be used include but should not be limited to, a photocopier, digital camera, film camera, overhead projector, hand held scanner, and desktop scanner.

### BRIEF DESCRIPTION OF THE DRAWINGS

FIG. 1 shows a trap constructed with a transparent material (100) that contains an attractant (102) and some opening (101) allowing the desired insect to enter the trap.

FIG. 2 shows the trap from FIG. 1 with insects (103) trapped in the attractant

FIG. 3 shows an image of the trapped insects being taken through a transparent side of the trap from FIG. 1 with some recording device (104)

FIG. 4 show the image that could have been recorded in the process in FIG. 3

### DETAILED DESCRIPTION OF THE INVENTION

The present invention will be described more fully with reference to the accompanying drawings, in which some embodiments of the invention are shown. Indeed these inventions may be embodied in many different forms and should not be construed as limited to the embodiments set forth herein; rather these embodiments are provided by way of example so that this disclosure will satisfy legal requirements.

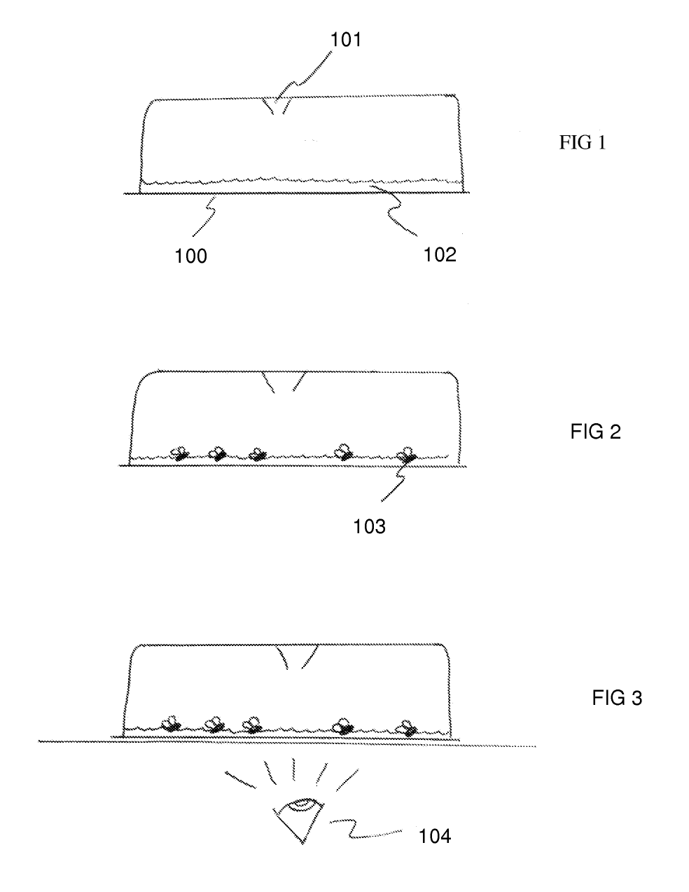

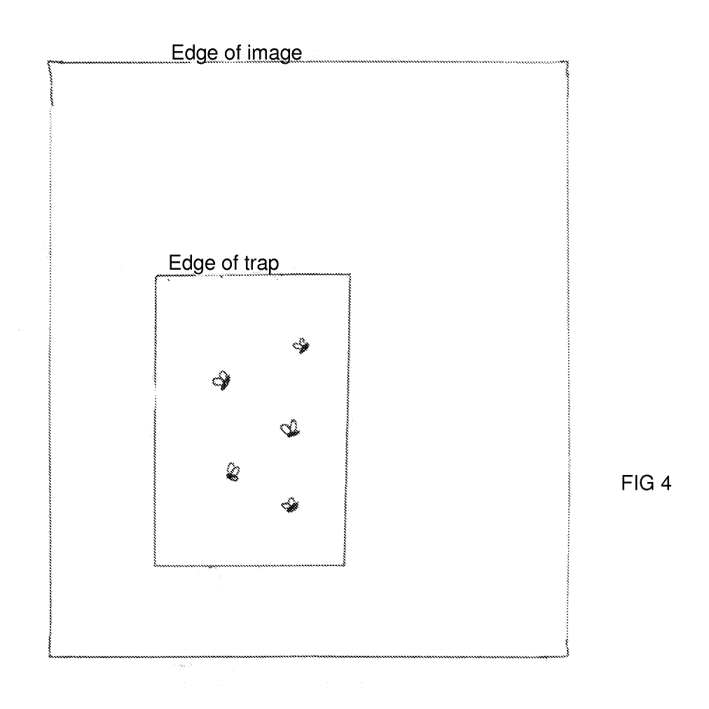

FIG. 1 illustrates a trap used for the capture of insects. The trap is enclosed with a suitable attractant within designed to attract the insect it is the intention to trap. The trap has suitable volume and some opening allowing the targeted insect access to the attractant. (1) Shown in FIG. 1 is an insect trap where at least one side of the trap is made from a transparent polymer. The transparent side in FIG. 1 was chosen for ease of illustration, in practice it could be any or even all sides of the trap made of a transparent polymer.

The insects, if present, enter the trap and become trapped within as shown in FIG. 2. Over time, more and more insects, if present, become trapped in the trap.

When it is time to monitor the trap and count the number of insects that have been trapped within, the trap is removed from its spot of application and the transparent surface is exposed to a recording device (2). The recording device is used as its function will allow. For example, if the device used is a photocopier, the transparent portion of the trap is placed on or near the glass scanning surface of the photocopier and the photocopier is activated per its operation instructions resulting in an image of the insects within the trap being recorded to a file or printed on a printed media. If the recording device is a camera, whether film type of digital type, the aperture of the camera is directed at a transparent surface of the trap and the camera is activated recorded an image of the insects inside the trap either to film or a digital file.

It is to be understood that the invention is not limited to the specific examples of the embodiments disclosed and that modifications and other embodiments are intended to be included within the scope of the appended claims. Although specific terms are employed herein, they are used in a generic and descriptive sense only and are not for purposes of limitation.

What is claimed is:

1. Using an insect trap that has at least one side made from a transparent polymer.

2. The process of counting the insects trapped in the trap described in claim 1 by placing the transparent side against a device whose purpose is to record an image such as a photocopier, digital scanner, camera, or overhead projector and recording the image of the insects trapped within.
